(19) United States
(12) Patent Application Publication
(10) Pub. No.: US 2008/0044585 A1
(43) Pub. Date: Feb. 21, 2008

(54) METHODS AND APPARATUS FOR EVAPORATING LIQUID PRECURSORS AND METHODS OF FORMING A DIELECTRIC LAYER USING THE SAME

(75) Inventors: Jeong-Soo Suh, Seoul (KR); No-Hyun Huh, Yongin-si (KR); Myeong-Jin Kim, Pyeongtaek-si (KR); Wan-Goo Hwang, Yongin-si (KR); Hyun-Wook Lee, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/771,517

(22) Filed: Jun. 29, 2007

(30) Foreign Application Priority Data
Aug. 21, 2006 (KR) 10-2006-0078535

(51) Int. Cl. B01J 19/08; B05B 5/025

(52) U.S. Cl. 427/457; 118/620

(57) ABSTRACT

The present invention provides methods and apparatus for evaporating a metal oxide layer precursor, including charging a liquid precursor, spraying the charged liquid precursor to form minute droplets; and vaporizing a solvent from the minute droplets. Methods of forming a dielectric layer are also provided.

### CROSS-REFERENCE TO RELATED APPLICATION

This application claims priority to Korean Patent Application No. 10-2006-78535, filed on Aug. 21, 2006, the disclosure of which is incorporated herein by reference in its entirety.

### FIELD OF THE INVENTION

The present invention relates to methods and apparatus for evaporating a precursor and methods of forming a dielectric layer using the same.

### BACKGROUND OF THE INVENTION

As semiconductor devices have become highly integrated, the cell area of semiconductor devices has decreased. Therefore, it can be problematic to provide a capacitor of the semiconductor device having a desired capacitance.

Generally, the capacitor may include a lower electrode, a dielectric layer and an upper electrode. In this instance, the dielectric layer may affect the capacitance of the capacitor. Particularly, the capacitance of the capacitor may be increased proportionately to the area of the dielectric layer. A conventional dielectric layer may have a simple cylindrical shape. Thus, when a cylindrical dielectric layer is formed on a small cell region, the capacitor may not have a desired capacitance. To address the above-mentioned problem, the shape of the dielectric layer may be changed into a concave shape, a stacked shape, etc.

The concave dielectric layer or the stacked dielectric layer having an equivalent oxide thickness of no more than about 5 Å may be desirable. However, since a zirconium oxide (ZrO₂) layer used as the conventional dielectric layer has an equivalent oxide thickness of about 7.5 Å, the zirconium oxide layer may not be suitable for the concave dielectric layer or the stacked dielectric layer. Thus, in some instances, a dielectric layer having a high dielectric constant and a perovskite structure such as a SrTiO₃ (STO) layer or a BaSrTiO₃ (BST) layer has been used.

The above-mentioned dielectric layer having the high dielectric constant may be formed by an atomic layer deposition (ALD) process using a precursor. The ALD process may include a process for evaporating a liquid precursor to form a gaseous precursor. Conventional methods of evaporating a precursor may use a bubbler, an atomizer, a nebulizer, a microwave vibrator, etc.

A precursor for forming the zirconium oxide layer such as TMA, TEMAH, TEMAZ, and the like, may have a vapor pressure higher than that of a precursor for forming the STO layer or the BST layer such as Sr(METHD)₂, Ba(METHD)₂, Ti(MPD)(THD)₂, and the like. Therefore, the precursor such as TMA, TEMAH, TEMAZ, and the like, may be more readily evaporated using a bubbler. In contrast, a precursor such as Sr(METHD)₂, Ba(METHD)₂, Ti(MPD)(THD)₂, and the like, may not be readily evaporated using the bubbler. Further, the precursor having a lower vapor pressure may not be evaporated using a nebulizer.

According to methods using an atomizer, a liquid precursor may be sprayed through a nozzle to form a droplet precursor. However, since the droplet may have a larger size, it may be useful to provide the droplet having a relatively high temperature in order to evaporate the droplet. Further, the droplet may be decomposed at a temperature of no less than a thermal decomposition temperature of the droplet to form a powder. However, the powder may clog a duct and/or orifice of the atomizer.

According to methods using a microwave vibrator, the concentration of a gaseous precursor may vary in accordance with the capacity of the microwave vibrator and a consumption amount of a liquid precursor.

### SUMMARY OF THE INVENTION

Embodiments of the present invention provide methods of more readily evaporating metal oxide layer precursors that possess a lower vapor pressure.

Some embodiments of the present invention provide methods of evaporating a precursor including charging a liquid precursor, spraying the charged liquid precursor to form minute droplets, and vaporizing a solvent from the minute droplets.

Further embodiments of the present invention provide an apparatus for performing the methods described herein as embodiments of the present invention. The apparatus may include an electrospray chamber, a nozzle in the electrospray chamber configured to spray a liquid precursor into the electrospray chamber, thereby forming minute droplets, a voltage applying member configured to charge the liquid precursor in the nozzle, and a heating member configured to vaporize a solvent from the minute droplets.

Embodiments of the present invention may also provide methods of forming a dielectric layer using the methods described herein as embodiments of the present invention. Methods of forming a dielectric layer may include charging a liquid precursor, spraying the charged liquid precursor to form minute droplets, vaporizing a solvent from the minute droplets to form a gaseous precursor, applying the gaseous precursor to a substrate to form a chemisorption layer on the substrate, and oxidizing the chemisorption layer to form a dielectric layer.

According to some embodiments of the present invention, a liquid precursor may be readily evaporated in the electrospray manner. Further, a dielectric layer having a high dielectric constant may be more readily formed using the gaseous precursor evaporated by the methods embodied herein.

### BRIEF DESCRIPTION OF THE DRAWINGS

The above and other features and advantages of the invention may become readily apparent by reference to the following detailed description, particularly when considered in conjunction with the accompanying drawings wherein:

FIG. 1 presents a cross-sectional view illustrating an apparatus for evaporating a precursor in accordance with some embodiments of the present invention;

FIG. 2 presents an enlarged perspective view illustrating a nozzle of the apparatus in FIG. 1;

FIG. 3 presents a flow chart illustrating a method of evaporating a precursor using the apparatus in FIG. 1 according to some embodiments;

FIG. 4 presents a cross-sectional view illustrating an apparatus for evaporating a precursor in accordance with some embodiments of the present invention;

FIG. 5 presents a cross-sectional view illustrating an apparatus for evaporating a precursor in accordance with some embodiments of the present invention; and

FIG. 6 presents a flow chart illustrating a method of evaporating a precursor in accordance with some embodiments of the present invention.

### DETAILED DESCRIPTION

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

Unless otherwise defined, all terms, including technical and scientific terms used in this description, have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Moreover, it will be understood that steps comprising the methods provided herein can be performed independently or at least two steps can be combined. Additionally, steps comprising the methods provided herein, when performed independently or combined, can be performed at the same temperature and/or atmospheric pressure or at different temperatures and/or atmospheric pressures without departing from the teachings of the present invention.

In the drawings, the thickness of layers and regions are exaggerated for clarity. It will also be understood that when a layer is referred to as being “on” another layer or substrate or a reactant is referred to as being introduced, exposed or feed “onto” another layer or substrate, it can be directly on the other layer or substrate, or intervening layers can also be present. However, when a layer, region or reactant is described as being “directly on” or introduced, exposed or feed “directly onto” another layer or region, no intervening layers or regions are present. Additionally, like numbers refer to like compositions or elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the present invention are further described herein with reference to cross-section illustrations that are schematic illustrations of idealized embodiments of the present invention. As such, variations from the shapes of the illustrations as a result, for example, of manufacturing techniques and/or tolerances, are to be expected. In particular, the regions illustrated in the figures are schematic in nature and their shapes are not intended to illustrate the precise shape of a region of a device and are not intended to limit the scope of the present invention.

As will be appreciated by one of ordinary skill in the art, the present invention may be embodied as methods of making and using compositions and devices as well as such compositions and devices resulting therefrom.

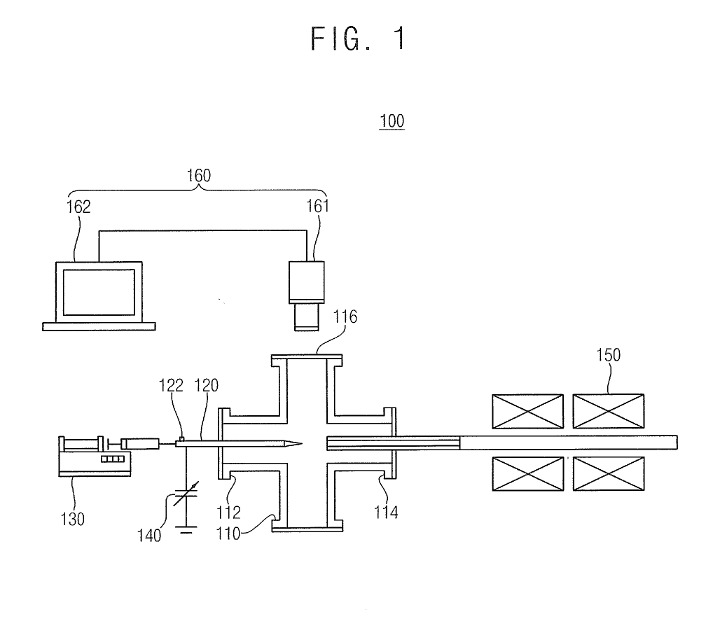

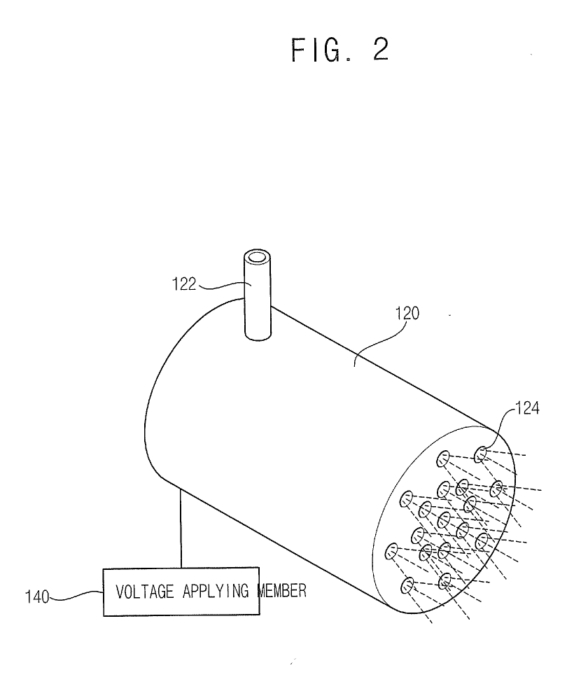

FIG. 1 presents a cross-sectional view illustrating an apparatus for evaporating a precursor in accordance with an embodiment of the present invention, and FIG. 2 is an enlarged perspective view illustrating a nozzle of the apparatus in FIG. 1.

Referring to FIG. 1, an apparatus 100 for evaporating a precursor in accordance with embodiments of the present invention may include an electrospray chamber 110, a nozzle 120, a pressuring member 130, a voltage applying member 140, a heating block 150, and a sensing member 160.

The electrospray chamber 110 may have an inflow passageway 112, an outflow passageway 114 and a window 116. A liquid precursor having a high viscosity and/or non-volatility, and a high vapor pressure, such as Sr(METHD)₂, Ba(METHD)₂, or Ti(MPD)(THD)₂, and the like, is introduced into the electrospray chamber 110 through the inflow passageway 112. The liquid precursor may be sprayed into the electrospray chamber 110 to form minute droplets. The droplets may then be exhausted through the outflow passageway 114.

The nozzle 120 may be inserted into the electrospray chamber 110 through the inflow passageway 112. With reference to FIG. 2, the nozzle 120 may have a cylindrical shape. Further, a thin long capillary may be formed along an inside of the nozzle 120. The liquid precursor may pass through the capillary. Further, the nozzle 120 may have an inlet 122 through which the liquid precursor is introduced. In particular embodiments, the inlet 122 may be formed at an outer face of the nozzle 120 along a direction at least substantially perpendicular to a flow direction of the liquid precursor in the nozzle 120. The inlet 122 may be in fluid communication with the capillary. A plurality of spray holes 124 may be formed through a side face of the nozzle 120. The liquid precursor may be sprayed through the spray holes 124 to form the minute droplets in the nanometer size range. The spray holes 124 may be in fluid communication with the capillary. Alternatively, the spray hole 124 may be a single hole. However, to form a greater quantity of gaseous precursors, more than a single spray hole 124 may be formed.

The pressurizing member 130 may be connected to the nozzle 120. The pressurizing member 130 may pressurize the liquid precursor introduced into the nozzle 120 through the inlet 122 toward the spray holes 124. According to some embodiments, the pressuring member 130 may include a syringe pump for pressurizing the liquid precursor through the capillary.

The voltage applying member 140 for charging the liquid precursor may be connected to the nozzle 120. Further, the voltage applying member 140 may be connected to a ground. Thus, negative charges may flow toward the ground so that the liquid precursor is charged with positive charges. Consequently, a repulsive force is applied between the positively charged liquid precursors so that the positively charged liquid precursor molecules generally do not collide with each other.

In particular embodiments, the heating block 150 is used as a heating member and is arranged adjacent to the outflow passageway 114 of the electrospray chamber 110. Thus, the minute droplets sprayed from the nozzle 120 may pass through the heating block 150 to vaporize a solvent from the minute droplets, thereby forming a gaseous precursor.

Further, the sensing member 160 may be positioned adjacent to the window 116 of the electrospray chamber 110. The sensing member 160 can detect whether the minute droplets are sprayed into the electrospray chamber 110. In such embodiments, the sensing member 160 may include a camera 161 such as a charge coupled device (CCD) camera and a monitor 162. The camera 161 can obtain, i.e., produce or record, an image from the inside of the electrospray chamber 110, particularly, a region where the minute droplets are sprayed through the spray holes 124 of the nozzle 120 through the window 116. The monitor 162 can display an image obtained by the camera 161.

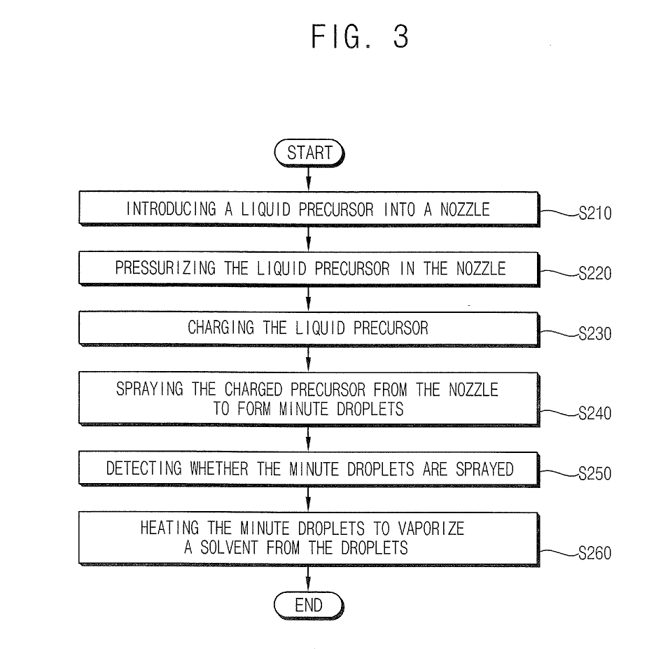

FIG. 3 presents a flow chart illustrating a method of evaporating a precursor using the apparatus in FIG. 1 according to some embodiments. Referring to FIGS. 1 to 3, in step S210, the liquid precursor may be introduced into the nozzle 120 through the inlet 122. The liquid precursor may flow into the capillary of the nozzle 120. In step S220, the syringe pump 130 may supply a pressure to the nozzle 120 to move the liquid precursor in the nozzle 120 toward the spray holes 124.

In step S230, the voltage applying member 140 may apply a voltage to the liquid precursor to charge the liquid precursor. Since the negative charges flow toward the ground, the liquid precursor may be charged with the positive charges. Therefore, the repulsive force is applied between the positively charged liquid precursors so that the liquid precursor molecules generally do not collide with each other. As a result, the positively charged liquid precursors may move toward the spray holes 124 with minimal interference.

In step S240, the positively charged liquid precursors may be sprayed into the electrospray chamber 110 from the spray holes 124 to form the minute droplets having a nanometer-sized diameter in the electrospray chamber 110.

In step S250, the camera 161 can obtain an image from the inside of the electrospray chamber 110. The monitor 162 can display the image obtained by the camera 161. Thus, one may detect the spray distribution of the minute droplets, such as whether the precursors are normally sprayed, by viewing the image on the monitor 162.

In step S260, the minute droplets may then be introduced into the heating block 150 through the outflow passageway 114. The heating block 150 can heat the minute droplets to vaporize the solvent from the minute droplets, thereby forming the gaseous precursors.

According to some embodiments, the liquid precursor may be sprayed through the nozzle to form the minute droplets having a nanometer-sized diameter. Therefore, the liquid precursor having a lower vapor pressure may be more readily evaporated in the electrospray manner.

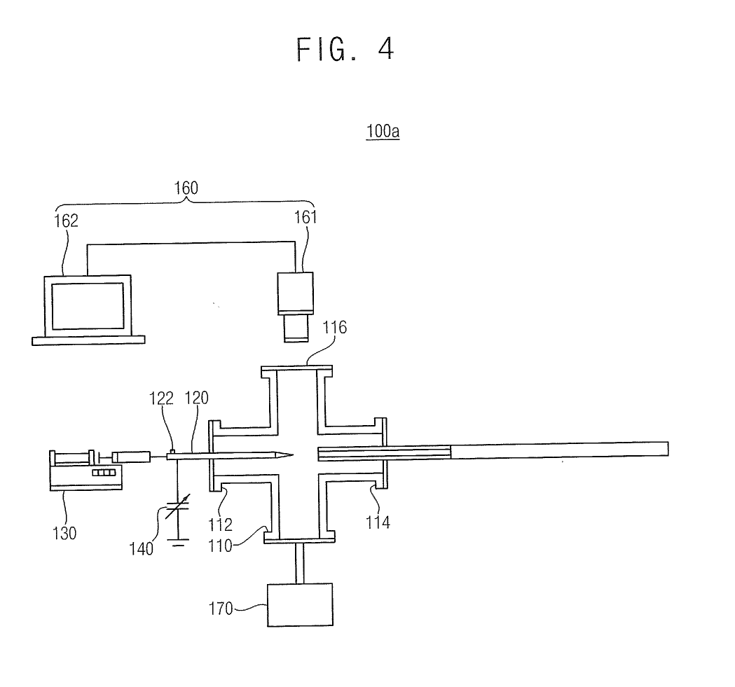

FIG. 4 presents a cross-sectional view illustrating an apparatus for evaporating a precursor in accordance with some embodiments of the present invention. More specifically, an apparatus 100a for evaporating a precursor in accordance with some embodiments include elements substantially the same or similar to those of apparatus 100 discussed above; however, in the present embodiment, a gas-supplying unit is substituted for the heating block described above. Thus, the same reference numerals refer to the same elements and any further illustrations with respect to the same elements are omitted herein.

Referring to FIG. 4, the apparatus 100a includes the gas-supplying unit 170 as a heating member. The gas-supplying unit 170 may be connected to the electrospray chamber 110. The gas-supplying unit 170 may supply a carrier gas having a higher temperature into the electrospray chamber 110 to evaporate the minute droplets sprayed from the nozzle 120. In this particular embodiment, the carrier gas may include an inert gas such as a nitrogen gas, an argon gas, and the like.

The method of evaporating the precursor using the apparatus 100a in FIG. 4 is substantially the same or similar to that illustrated with reference to FIG. 3 except that the minute droplets are heated using the carrier gas having a relatively high temperature. Thus, any further illustrations with respect to the method of evaporating the precursor using the apparatus 100a in FIG. 4 are omitted.

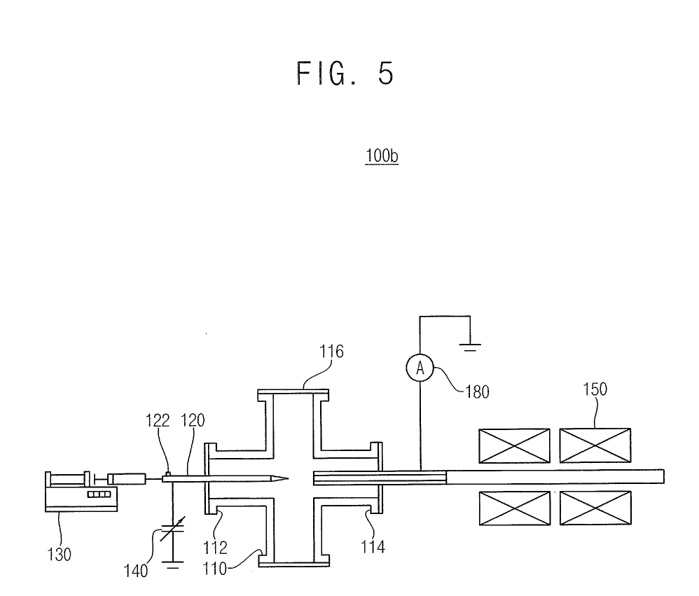

FIG. 5 presents a cross-sectional view illustrating an apparatus for evaporating a precursor in accordance with further embodiments of the present invention. More specifically, an apparatus 100b for evaporating a precursor in accordance with a particular embodiment includes elements substantially the same or similar to those of apparatus 100 described above except for the absence of a sensing member. Thus, the same reference numerals refer to the same elements and any further illustrations with respect to the same elements are omitted herein.

Referring to FIG. 5, the apparatus 100b of this particular embodiment includes the ammeter 180 as the sensing member. The ammeter 180 may be connected to the electrospray chamber 110. The ammeter 180 can measure a current of the charged minute droplets in the electrospray chamber 110 to detect whether the minute droplets are normally sprayed.

Further, a method of evaporating the precursor using the apparatus 100b in FIG. 5 is substantially the same or similar to that illustrated with reference to FIG. 3 except the ammeter 180 is used in place of the camera. Thus, any further illustrations with respect to the method of evaporating the precursor using the apparatus 100b in FIG. 5 are omitted.

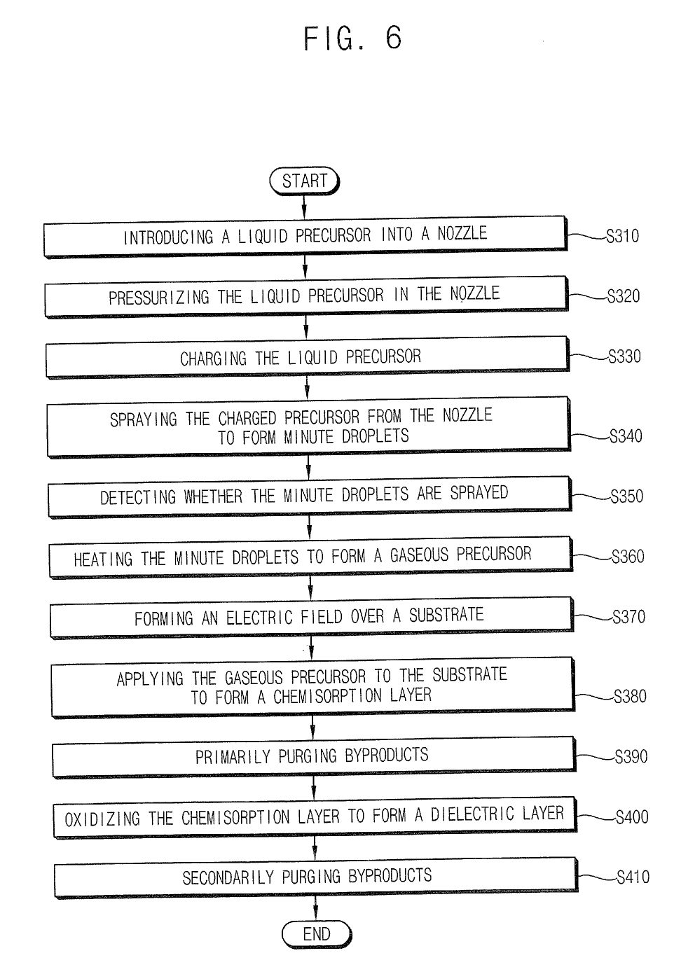

FIG. 6 presents a flow chart illustrating a method of evaporating a precursor in accordance with further embodiments of the present invention.

Referring to FIG. 6, in step S310, the liquid precursor having a lower vapor pressure such as Sr(METHD)₂, Ba(METHD)₂, Ti(MPD)(THD)₂, and the like, may be introduced into the nozzle 120 through the inlet 122.

In step S320, the syringe pump 130 can supply a pressure to the nozzle 120 to move the liquid precursor in the nozzle 120 toward the spray holes 124.

In step S330, the voltage applying member 140 can apply a voltage to the liquid precursor to charge the liquid precursor. Since the negative charges flow toward the ground, the liquid precursor may be charged with the positive charges. Therefore, the repulsive force is applied between the positively charged liquid precursors so that the liquid precursor molecules generally do not collide with each other. As a result, the positively charged liquid precursors may move toward the spray holes 124 with minimal interference.

In step S340, the positively charged liquid precursors may be sprayed into the electrospray chamber 110 from the spray holes 124 to form the minute droplets having a nanometer-sized diameter in the electrospray chamber 110.

In step S350, the camera 161 can obtain an image from an inside portion of the electrospray chamber 110. The monitor 162 can display the image obtained by the camera 161. Thus, one may detect the spray distribution of minute droplets by viewing the image on the monitor 162.

In step S360, the minute droplets may be introduced into the heating block 150 through the outflow passageway 114. The heating block 150 can heat the minute droplets to vaporize the solvent from the minute droplets, thereby forming the gaseous precursors.

In step S370, an electric field may be formed over a semiconductor substrate. In this particular embodiment, an electrode is arranged between the semiconductor substrate and the heating block 150. A voltage may be applied between the semiconductor substrate and the electrode to form an electric field between the semiconductor substrate and the electrode. A distribution of the gaseous precursors may be readily controlled using the electric field. Consequently, the gaseous precursors may be uniformly distributed over the semiconductor substrate using the electric field.

In step 380, the uniformly distributed gaseous precursors may be applied to the semiconductor substrate to form a chemisorption layer on the semiconductor substrate.

In step S390, byproducts generated while forming the chemisorption layer may be removed using a purge gas.

In step S400, an oxidizing agent may be applied to the chemisorption layer. The oxidizing agent and the chemisorption layer may be chemically reacted with each other to oxidize the chemisorption layer, thereby forming a dielectric layer having a high dielectric constant such as an STO layer, a BST layer, and the like, on the semiconductor substrate.

In step S410, byproducts generated while forming the dielectric layer may be removed using a purge gas.

According to some embodiments of the present invention, the liquid precursor having a lower vapor pressure such as Sr(METHD)₂, Ba(METHD)₂, Ti(MPD)(THD)₂, and the like, may be readily evaporated in the electrospray manner. Further, the dielectric layer having a higher dielectric constant may be more readily formed using the gaseous precursor evaporated by the above-mentioned methods provided as embodiments of the present invention.

Having described various embodiments of the present invention, it is noted that modifications and variations can be made by persons skilled in the art in light of the above teachings. It is therefore to be understood that changes may be made in the particular embodiments of the present invention disclosed herein which are within the scope and the spirit of the invention outlined by the appended claims.

What is claimed is:

1. A method of evaporating a metal oxide layer precursor, comprising:
charging a liquid precursor;
spraying the charged liquid precursor to form minute droplets; and
vaporizing a solvent from the minute droplets.

2. The method of claim 1, wherein charging the liquid precursor comprises applying a voltage to the liquid precursor.

3. The method of claim 1, wherein vaporizing the solvent comprises exposing the minute droplets to a heating block.

4. The method of claim 1, wherein vaporizing the solvent comprises exposing the minute droplets to a carrier gas having a high temperature.

5. The method of claim 1, further comprising detecting a spray distribution of the charged precursor.

6. The method of claim 5, wherein detecting the spray distribution of the charged precursor comprises obtaining an image from a region where the charged precursor is sprayed.

7. The method of claim 5, wherein detecting the spray distribution of the charged precursor comprises measuring an amount of current in a region where the charged precursor is sprayed.

8. The method of claim 1, wherein the liquid precursor comprises at least one of Sr(METHD)₂, Ba(METHD)₂ or Ti(MPD)(THD)₂.

9. An apparatus for evaporating a metal oxide layer precursor, comprising:
an electrospray chamber;
a nozzle in the electrospray chamber configured to spray a liquid precursor into the electrospray chamber, thereby forming minute droplets;
a voltage applying member configured to charge the liquid precursor in the nozzle; and
a heating member configured to vaporize a solvent from the minute droplets.

10. The apparatus of claim 9, further comprising a pressurizing member configured to supply a pressure to the liquid precursor in the nozzle.

11. The apparatus of claim 10, wherein the pressurizing member comprises a syringe pump.

12. The apparatus of claim 9, wherein the nozzle has a plurality of spray holes configured to spray the liquid precursor.

13. The apparatus of claim 9, wherein the heating member comprises a heating block positioned adjacent to an opening of the electrospray chamber configured to allow passage of the minute droplets.

14. The apparatus of claim 9, wherein the heating member comprises a gas-supplying unit configured to supply a carrier gas having a higher temperature into the nozzle.

15. The apparatus of claim 9, further comprising a sensing member configured to detect a spray distribution of the charged precursor.

16. The apparatus of claim 15, wherein the sensing member comprises:
a camera configured to obtain an image inside the electrospray chamber; and
a monitor for displaying the image obtained by the camera.

17. The apparatus of claim 15, wherein the sensing member comprises an ammeter configured to measure a current in the electrospray chamber.

18. The apparatus of claim 9, wherein the liquid precursor comprises at least one of Sr(METHD)₂, Ba(METHD)₂ or Ti(MPD)(THD)₂.

19. A method of forming a dielectric layer, comprising:
charging a metal oxide layer liquid precursor;
spraying the charged liquid precursor to form minute droplets;
vaporizing a solvent from the minute droplets to form a gaseous precursor;
applying the gaseous precursor to a substrate to form a chemisorption layer on the substrate; and
oxidizing the chemisorption layer to form a dielectric layer.

20. The method of claim 19, further comprising forming an electric field on the substrate.

21. The method of claim 19, wherein after forming the chemisorption layer and/or the dielectric layer, the method further comprises purging byproducts generated while forming the chemisorption layer and/or the dielectric layer.

22. The method of claim 19, wherein the liquid precursor comprises at least one of Sr(METHD)₂, Ba(METHD)₂ or Ti(MPD)(THD)₂.
